(19) United States
(12) Patent Application Publication
(10) Pub. No.: US 2025/0100350 A1
(43) Pub. Date: Mar. 27, 2025

(54) METHOD FOR THERMAL CONTROL OF A PLURALITY OF COMPONENTS IN A VEHICLE

(71) Applicant: AUDI AG, Ingolstadt (DE)

(72) Inventors: Paul BÖCKENHOFF, Ingolstadt (DE); Hendrik GRONAU, Ingolstadt (DE)

(21) Appl. No.: 18/883,704

(22) Filed: Sep. 12, 2024

(30) Foreign Application Priority Data
Sep. 21, 2023 (DE) 102023125573.8

(51) Int. Cl. B60H 1/22; G07C 5/00

(52) U.S. Cl. CPC B60H 1/22; G07C 5/008; B60H 2001/224

(57) ABSTRACT

A method for the thermal control of a plurality of components in a vehicle is provided, wherein the vehicle includes as one component at least one computing unit which is configured to execute computations in the vehicle and the vehicle includes as a further component at least one drive train, wherein the computing unit is configured to execute computations required for the operation of the vehicle and additionally to repeatedly execute an exchange of data with a server arranged outside the vehicle, wherein in the method, the actual temperature of the computing unit and of the drive train is determined, and the exchange of data between the computing unit and the server is carried out when the actual temperature of the drive train is below a lower operating temperature threshold of the drive train. A device for performing the method and a vehicle with the device is also provided.

### BACKGROUND

### Technical Field

The present disclosure relates to a method for the thermal control of a plurality of components in a vehicle, wherein the vehicle includes as one component at least one computing unit which is configured to execute computations in the vehicle and the vehicle includes as a further component at least one drive train, wherein the computing unit is configured to execute computations required for the operation of the vehicle and additionally to repeatedly execute an exchange of data with a server arranged outside the vehicle, wherein in the method, the actual temperature of the computing unit and of the drive train is determined, and the exchange of data between the computing unit and the server is carried out when the actual temperature of the drive train is below a lower operating temperature threshold of the drive train. The present disclosure also relates to a device for carrying out the method and a vehicle with such a device.

### Description of the Related Art

Vehicles, such as motor vehicles, have ever more electronics that require computing power to operate. In the future, when the aim is to achieve at least partial autonomous driving of vehicles, it is to be expected that the computing power required will continue to rise sharply. The computing power is provided by one or a plurality of processors in the vehicle. These processors generate waste heat when executing the necessary computations, which waste heat must be dissipated by the respective processor. The exchange of large amounts of data between the vehicle and an infrastructure accessible by a wireless connection requires high computing power, which generates a large amount of waste heat. It is to be expected that in the near future, waste heat in the range of several hundred watts will be generated to execute the necessary computations and data actions. Currently, computations are executed in the vehicle when they occur and the resulting waste heat is dissipated by the processors. Active cooling systems are in part used for the dissipation of this waste heat, which systems cool the processor or processors during energy consumption. The energy required for these active cooling systems is taken from the battery of the vehicle, such as in the case of electrically-driven vehicles. This energy used for active cooling of the processors is then no longer available for other functions in the vehicle, which increases the energy consumption of the vehicle or, in the case of electrically-driven vehicles, reduces the range.

The document DE 10 2018 212 537 A1 describes a device and a method for raising a temperature in at least one part of a vehicle. In the method, waste heat generated by a processor when executing computations is fed to at least one other part of the vehicle and used there. It is moreover proposed to have additional computations executed by the processor when heat is required in the vehicle and to use the waste heat generated to meet this heat requirement.

The document DE 10 2019 114 820 B3 describes a method for heating a motor vehicle part. In the method, waste heat which is generated by a computing device is fed to another vehicle part. The method, moreover, proposes that when the vehicle is stationary, when only a few computing operations are required in the vehicle, computing operations that are independent of the operation of the vehicle can be carried out. In this way, more waste heat is available for heating the other part of the vehicle.

The document CN 115107576 A describes a method for temperature management in a vehicle. In the method, the behavior of the driver is predicted based on existing data from a driver profile. Based on this prediction of the behavior of the driver, the temperature of components in the vehicle is controlled.

### BRIEF SUMMARY

The task of the present disclosure is to more efficiently use waste heat which is generated when computations are carried out in a vehicle, such as to reduce the energy requirement of the vehicle.

The present disclosure provides a method for thermal control of a plurality of components in a vehicle, wherein the vehicle includes as a component at least one computing unit which is configured to execute computations in the vehicle, wherein computing heat is generated in the computing unit during these computations and the vehicle includes as a further component at least one drive train, which drive train is provided to drive the vehicle and which generates drive heat during operation,

wherein the computing unit is configured to execute computations required for the operation of the vehicle and, in addition, to carry out a repeated exchange of data with a server arranged outside the vehicle, this in order to compare vehicle data with centrally stored data,

wherein, in the method, the actual temperature of the computing unit and of the drive train is determined, and

the exchange of data between the computing unit and the server is carried out when the actual temperature of the drive train is below a lower operating temperature threshold of the drive train, wherein the computing heat generated during the exchange of data is fed at least in part to the drive train in order to increase its actual temperature.

The method described herein is used for thermal control and thus for the adjustment of the temperature of a plurality of components in a vehicle. The vehicle is preferably an at least partially electrically-driven vehicle, which has a battery as an energy storage device as well as an electric drive motor. The method can, however, also be carried out in a vehicle that additionally or exclusively has an internal combustion engine as a drive. One of the two components, the temperature of which is controlled or influenced in the vehicle by the method, is a computing unit. The term “computing unit” can refer to one or a plurality of processors. The computing unit is provided to carry out computations in the vehicle, for example, for evaluating sensors and for the control and regulation of the drive and brakes. The computing unit includes a sub-area which is configured to carry out the method. The method can, for example, be executed by a separate processor or be taken over by a processor that also executes other computing tasks. If the computing unit is used to execute computations, waste heat is generated, which is referred to as computing heat. The vehicle includes as a component a drive train, which is intended to drive the vehicle. The drive train can include, for example, a battery, an electrical machine, and power electronics for the control of the electrical machine and the battery. The vehicle can include further components that are thermally controlled by the method. Such a component can be, for example, an air conditioning unit in the vehicle interior, which sets the desired temperature for the occupants. The method makes it possible to transfer heat within the vehicle to where it is needed. The drive train generates waste heat during operation of the vehicle, which heat is referred to as drive heat. The drive train has an operating temperature at which the drive train can be used in an efficient manner and at which wear is low. This operating temperature is above the normal ambient temperature of the vehicle and adjusts itself over time during operation due to the drive heat. At the start of a journey, it is, however, necessary to warm up the drive train in order to bring it to the desired operating temperature. The operating temperature is to be understood to be a temperature range that lies between a lower operating temperature threshold and an upper operating temperature threshold.

The computing unit is configured to execute computations that are required for the current operation of the vehicle. These computations relate to actions or evaluations that arise directly during driving. Evaluations of various sensors, the operation of a navigation system or the controlling of the drive, steering and brakes are, for example, required for the current operation of the vehicle. In addition, and beyond this, the computing unit is configured to undertake an exchange of data with a server located outside the vehicle. During this exchange of data, data collected during operation of the vehicle is transmitted and evaluated or compared on the server located outside the vehicle. This exchange of data must be carried out repeatedly in order to compare the data of the vehicle with the data on the server located outside the vehicle. It is, however, not necessary to carry out this exchange of data at a precisely predetermined time. The exchange of data can also be executed with a certain time delay to the operation of the vehicle. The method described herein aims to carry out this exchange of data from the vehicle or alternatively from the computing unit with a server arranged outside the vehicle when this is optimal for the energy management of the vehicle. According to the present disclosure described herein, the actual temperature of the computing unit and the drive train is determined in the method, such as in a continuous manner. For this purpose, corresponding temperature sensors can be provided in both components. In one case in which the determined actual temperature of the drive train is below its lower operating temperature threshold, there is a need to feed heat to the drive train in order to bring it into the operating temperature range. As per the method described herein, in such a state, computing heat generated by the computing unit is fed to the drive train in order to increase its actual temperature. If the determined actual temperature of the computing unit falls within the optimum operating temperature of the computing unit, the computing heat, not having any additional tasks for the computing unit, can then be transferred to the drive train or another component in the vehicle. If the actual temperature of the computing unit is, however, below its optimum operating temperature or if the computing heat released is not sufficient to raise the actual temperature of the drive train to a temperature above the lower operating temperature threshold, data is exchanged between the computing unit and the server located outside the vehicle in order to increase the amount of computing heat generated. In this way, the exchange of data, which is required within a certain period of time anyway, and which generates a larger amount of computing heat, is carried out when the computing heat inside the vehicle can be optimally used to heat the drive train. As a result, the computing heat arising for the exchange of data is used more efficiently and the overall energy requirement of the vehicle is reduced. If the exchange of data is carried out arbitrarily, without taking into account the temperature of other components in the vehicle, the computing heat generated for this purpose must in many cases be dissipated by cooling, often also by active cooling, which increases the energy consumption of the vehicle. In the case of electrically-driven vehicles, the method described herein, which significantly reduces the energy required to cool the computing unit or alternatively to dissipate the computing heat, optimizes the energy consumption and increases the range of the vehicle. At the same time, the method reduces the energy consumption for heating the drive train to operating temperature, which also increases the range of the vehicle. The method enables the efficient use of the computing heat generated for the necessary computations for the operation of other components in the vehicle and therefore to reduce the overall energy consumption. A heat exchanger may be provided to transfer the computing heat or alternatively the thermal energy generated during the computation, which heat exchanger transfers the computing heat from the computing unit to the drive train and vice versa. Further heat exchangers may be provided to transfer computing heat to other components in the vehicle. Of course, it is also possible, in a case in which the actual temperature of the drive train is already within the range of its operating temperature, to transfer heat, such as drive heat, from the drive train to the computing unit or to other components in the vehicle.

In one embodiment of the method, the exchange of data between the computing unit and the server may be carried out at the beginning of a journey, after a rest period of the vehicle, such as after a cold start of the vehicle, and data which were determined in the vehicle before the rest period of the vehicle are transmitted during the exchange of data. In this embodiment, the exchange of data between the computing unit and the server may be carried out in the method in a state of the vehicle in which the vehicle, such as the drive train, is only at ambient temperature. This state is present during a cold start. A cold start is understood to be the start of a journey in which the vehicle was previously at rest and all components are at the temperature of the vehicle environment. The advantage of carrying out the exchange of data at the start of such a journey is that the generated computing heat can be used in an efficient manner to heat the drive train to a temperature above the lower operating temperature threshold. Up to now, this type of exchange of data, in which, data from the previous journey is exchanged between the computing unit and the central server, has been carried out after the journey. In a state after the journey, the drive train of the vehicle is warmed up to operating temperature and the computing heat cannot be used to warm it up. Instead, the computing heat must be dissipated by cooling during an exchange of data after the vehicle has been driven, which requires energy. In the described embodiment of the method, the exchange, at the start of another journey, of data from the last journey before a rest period therefore saves energy used for dissipation of the computing heat as well as energy used for heating the drive train. Alternatively, data may also be exchanged during the journey when the actual temperature of the drive train falls below the lower operating temperature threshold. Such a state can occur, for example, during a journey in which very low ambient temperatures prevail and wherein at the same time little drive energy is required, so that little drive heat is generated in the drive train.

In one embodiment of the method, in which the actual temperature of the drive train is higher than a lower operating temperature threshold of the drive train, an exchange of data between the computing unit and the server may only be carried out if the computing heat generated thereby can be dissipated by a passive cooling system of the vehicle, such as where essentially no energy from a battery of the vehicle is required for this dissipation of the computing heat. In a case in which the actual temperature of the drive train is higher than its lower operating temperature threshold and, at the same time, an exchange of data is useful or necessary, this exchange is carried out if the computing heat generated by the exchange of data can be dissipated by a passive cooling system. A passive cooling system is understood to be a cooling system that does not require any energy from the energy storage device of the vehicle to dissipate the waste heat. Such a passive cooling system can, for example, be an airflow cooler through which a cooling medium flows that has previously absorbed heat from the computing unit. Alternatively, the passive cooling system may also be a heat conducting plate, which absorbs heat from the computing unit and passively dissipates it to the vehicle environment.

In one embodiment, the computing heat generated by the exchange of data may be emitted to the environment of the vehicle by a cooler and/or the time for exchange of data between the computing unit and the server is determined by the computing unit on the basis of temperature sensors, cameras or a weather forecast. This embodiment of the method is also carried out if the actual temperature of the drive train is higher than its lower operating temperature threshold. In this case, the resulting computing heat can be transferred to the vehicle environment by a cooler. In some embodiments, the heat from this cooler may be passively dissipated to the vehicle environment by convection. In this way, no or only very little energy from the energy storage device of the vehicle is required to operate the cooler. Alternatively or additionally, information from various sensors on the vehicle may be incorporated into the method for determining the ideal time to carry out an exchange of data. In this way, for example, temperatures inside and outside the vehicle can be determined by temperature sensors. Alternatively, it is possible to use cameras installed in or on the vehicle to determine whether the sun is shining, the sky is overcast or it is night. Based on this data, the exchange of data can then be postponed to a time when the sun is not shining and, for example, the ambient temperature of the vehicle is therefore lower. When the ambient temperature of the vehicle is lower, a larger amount of waste heat can be dissipated by passive cooling systems. It is possible for the computing unit to access a weather forecast, for example, by the connection to the server. Based on the weather forecast, the exchange of data can then be postponed to a time when falling outside temperatures or rain are forecast. Even in these outdoor conditions, a large amount of waste heat may be passively dissipated outside the vehicle. It is also possible for the computing unit to use several sensors or information sources as a basis for determining the optimum time for the exchange of data.

In some embodiments, if the actual temperature of the drive train is below a lower operating temperature threshold of the drive train, in addition to or as an alternative to the exchange of data between the computing unit and the server, a computation independent of the operation of the vehicle may be executed by the computing unit and the thereby generated computing heat is at least partially fed to the drive train, wherein this independent computation is executed based on data transmitted by the server. In this embodiment of the method, in a case in which heat is required to heat the drive train to a temperature above the lower operating temperature threshold, at least one computation independent of the operation of the vehicle is executed by the computing unit as an alternative to or in addition to the exchange of data between the computing unit and a server. Such a computation is not required for the actual operation of the vehicle. By way of example, it is possible to outsource computations of other applications to the computing unit of the vehicle, which transmits the results back to a server after the computations have been executed. Capacity is made available in the computing unit of the vehicle for external computations, which can be carried out for a fec. In this way, an external user receives computing capacity from the computing unit of the vehicle and the computations executed in the vehicle generate computing heat which can be used to heat another component, such as the drive train. By selling the computing power, part of the energy required to generate the computing heat or to heat the drive train can be financed. The carrying out of such a computation, which is independent of the operation of the vehicle, can, advantageously be carried out at the beginning of a journey, after a cold start of the vehicle, in order to provide as much computing heat as possible to warm up the drive train.

In one embodiment, the computing unit may predict the behavior of one or a plurality of drivers of the vehicle based on data collected about the respective driver and/or based on data provided by the respective driver, and, if the actual temperature of the drive train is below a lower operating temperature threshold of the drive train, the exchange of data between the computing unit and the server is at least partially executed before the journey of the vehicle is started and the computing heat generated during the exchange of data is at least partially fed to the drive train in order to preheat it. In this embodiment, the computing unit predicts the behavior of the driver who is driving the vehicle. A plurality of drivers per vehicle can be registered in one vehicle. The recognition of the respective driver can, for example, take place by a personalized key or entered manually at the start of the journey. Data collected relating to each driver can be stored in a memory of the computing unit. Such collected data can be, for example, routes already driven and the times at which these routes were driven. The prediction of the behavior of the respective driver can also be made on the basis of data provided by the driver, for example, by entering the destination into a navigation system. In this embodiment of the method, the prediction of the behavior of the driver may be incorporated into the selection of the time at which data is exchanged between the computing unit and an external server. By way of example, based on the prediction, the exchange of data can be started before the actual journey begins in order to preheat the drive train of the vehicle. If the prediction shows that a certain driver drives the same route every day at a certain time, for example, to get to work, the exchange of data can begin before the predicted journey and its computing heat can be used to warm up the drive train or other components in the vehicle. In this way, the driver finds a thermally prepared vehicle at the start of the journey, the drive train of which is already at an optimum operating temperature. Artificial intelligence, which is implemented either in the vehicle itself or on a server located outside the vehicle, can also be used to predict the behavior of the driver. It is, moreover, possible for data from a navigation system relating to a route already driven by another driver to be used in the method. This data can, for example, indicate stages in which little drive energy is required, so that an exchange of data can be moved to such a stage in order to keep the drive train at the desired operating temperature during the journey. By using artificial intelligence, the method can continuously improve the thermal control of the components in the vehicle and make it more efficient by learning from the data collected and entered.

In some embodiments, the data collected related to the respective driver may include known, previously driven routes, known speed profiles, and/or known travel times and/or the data provided by the respective driver includes entries from a calendar or explicitly entered driving plans and/or the respective driver is asked before the start of the journey whether they want to drive a known route. The data collected by the respective driver may include all data collected by the vehicle on previously traveled, identical or similar routes. This data can include destinations, distances, and speed profiles. It is advantageous if the data provided by the respective driver includes entries from an electronic calendar containing the time and destination of a planned journey. Such calendar entries are helpful for an exchange of data shortly before a planned journey in order to preheat the drive train and other components in the vehicle using the computing heat. It is possible for the driver to manually enter journey plans, for example, a planned journey for the next day, on or in the vehicle, which also enables the drive train to be preheated before the journey begins. It is advantageous if the computing unit provides the driver with one or a plurality of possible, predicted destinations to choose from at the start of the journey. In this way, in the method a prediction made by the computing unit can be easily confirmed, whereby incorrect predictions and therefore non-optimal thermal management of the components in the vehicle can be avoided.

In one embodiment, the actual temperature of the drive train may be higher than a lower operating temperature threshold of the drive train, an exchange of data between the computing unit and the server is undertaken, if, in accordance with the predicted behavior of the respective driver of the vehicle, the generated computing heat can be dissipated by a passive cooling system of the vehicle, or if it is predicted that the actual temperature of the drive train will fall below the lower operating temperature threshold of the drive train and thereby there is a need to transfer the computing heat generated during the exchange of data to heat the drive train. In this embodiment, as described above, a prediction of the behavior of the respective driver of the vehicle may be carried out. This prediction may also be used, in a state in which the drive train is already at operating temperature, to define the timepoint for the exchange of data in such a way that the thereby generated computing heat can be dissipated by a passive cooling system of the vehicle and at least the energy required for active cooling of the computing unit is saved. Alternatively, if the prediction shows that the drive train will cool down below the lower operating temperature threshold during the journey, it is possible to schedule the exchange of data for this time in order to counteract excessive cooling of the drive train or another component.

Embodiments of the present disclosure provide a device for thermal control of a plurality of components in a vehicle, including at least one computing unit which forms a component of the vehicle and which is configured to execute computations in the vehicle, at least one drive train, which forms a component of the vehicle and is provided to drive the vehicle, and at least one heat exchanger, which is thermally connected at least to the computing unit and the drive train, wherein the computing unit is configured to execute a method described herein and wherein the heat exchanger is configured, in a controlled manner through the computing unit, to transfer heat from the computing unit to the drive train or vice versa.

The device described herein is configured to execute a method for thermal control of a plurality of components in a vehicle described above. The device is arranged in a vehicle, such as in an at least partially electrically-driven vehicle. In this way, the device includes components which also belong to the vehicle.

The device described herein includes at least one computing unit, which is configured to execute computations in the vehicle. The computing unit is configured to control other components of the device and to execute a method described herein. The computing unit is, configured to repeatedly exchange data with a server located outside the vehicle in order to compare vehicle data with centrally stored data. This exchange of data is used to compare data generated or determined in the vehicle with data stored on a server. The exchange of data and the requirements as to when and at what interval this exchange of data must or should be carried out are described in connection with the method. The device includes at least one drive train, which is provided to drive the vehicle. This drive train can, for example, include an electric battery and an electric drive motor. On top of the drive train, the device may include further components in a vehicle which are to be thermally controlled. The device may include at least one heat exchanger, which forms the technical means for exchanging heat between the computing unit and the drive train. The heat exchanger can be configured, for example, to transfer computing heat generated in the computing unit to the drive train in order to bring it to an actual temperature above its lower operating temperature threshold. The heat exchanger can also, however, be used in the opposite direction for heat transfer, for example, to transfer drive heat from the drive train to the computing unit or to another component of the device. The heat exchanger can, for example, be configured as a fluid-conducting ring line that is thermally connected to both the computing unit and the drive train. The fluid in the ring line absorbs heat at one component and releases it again at the other component. Alternatively, the heat exchanger can also, for example, be configured as a heat pump which transports heat between two different temperature levels of two different components of the device. A heat pump of this type can likewise include a fluid line containing a medium that is vaporized in one component for heat transport and condensed again in another component. It is also possible to configure the heat exchanger as a simple, thermally conductive solid body, for example, as a strip made of a thermally conductive material. The computing unit is configured to carry out a method described herein and, as part of this method, to control the heat exchanger in such a way that the required heat exchange takes place between two components in the vehicle, such as between the computing unit and the drive train. The device described herein has a simple construction and can be integrated into a vehicle with little effort. The device efficiently utilizes waste heat generated during computations by the computing unit in a vehicle in order to reduce the energy requirement of the vehicle.

Embodiments of the present disclosure provide a vehicle, such as by an at least partially electrically-driven vehicle, with a device described herein. The device, which is part of the vehicle described herein, enables a method to be carried out in the vehicle. In this way, it is possible to use waste heat generated during computations more efficiently, thereby reducing the energy requirement of the vehicle.

Features, effects and advantages which are disclosed in connection with the method are also deemed to be disclosed in connection with the device and the vehicle. The same applies in the opposite direction; features, effects and advantages which are disclosed in connection with the device and the vehicle are also deemed to be disclosed in connection with the method.

### BRIEF DESCRIPTION OF THE SEVERAL VIEWS OF THE DRAWINGS

The present disclosure is shown schematically in the drawing with reference to one embodiment and is described further with reference to the drawing.

FIG. 1 shows, in a schematic view, an embodiment of a vehicle with a device.

### DETAILED DESCRIPTION

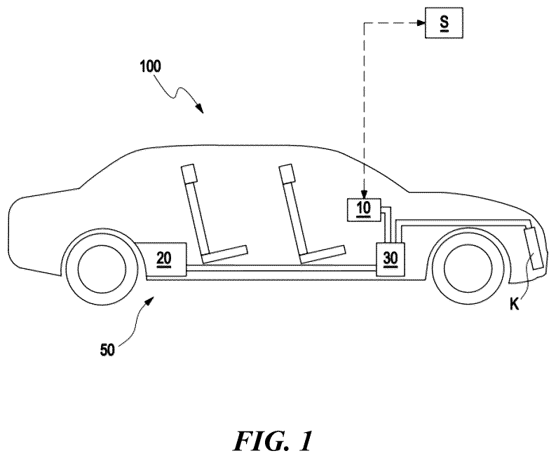

FIG. 1 shows a schematic view of an embodiment of a vehicle 100 with a device 50. The vehicle 100 shown is an electrically-driven vehicle 100. A drive train 20, which is symbolized in the drawing by a box-shaped housing near the bottom of the vehicle, is provided to drive the vehicle 100. The drive train 20 comprises an electric battery, an electric drive motor and the power electronics required for the control of the drive train 20. A computing unit 10 is symbolized at a front of the vehicle 100, which computing unit is intended to carry out computations in the vehicle 100. Beyond this, this computing unit 10 can also execute computations that are independent of the actual operation of the vehicle 100. The computing unit 10 is, moreover, configured to repeatedly exchange data with a server S located outside the vehicle 100. Such an exchange of data is necessary in order to exchange and compare data collected or entered in the vehicle 100 with a data memory located on the server S. Such an exchange of data helps, for example, to collect and evaluate information about the vehicle and its driver in order to continuously improve the vehicle 100 and its control electronics. The data exchange between the computing unit 10 and the server S occurs by a wireless connection, for example, by a radio link or a mobile phone connection. The vehicle 100, moreover, comprises a cooler K, which is arranged facing to the right on the front of the vehicle 100. This cooler K is provided to passively emit heat to the vehicle environment when all components of the device 50 are already sufficiently heated and at the desired operating temperature. The cooler K is configured as an airflow cooler, around which the airflow flows when the vehicle is moving. The airflow absorbs heat from the cooler K by convection as it flows around it and then releases it back into the vehicle environment. The evacuation of heat from the cooler K therefore takes place passively and does not require any energy from the electric battery of the vehicle 100. The cooler K is thus a passive cooling system of the vehicle 100. The illustrated vehicle 100 comprises a heat exchanger 30 in its device 50, which is shown symbolically in the vicinity of a vehicle floor. This heat exchanger 30 is provided to transport heat between different components of the device 50. In the embodiment shown, the heat exchanger 30 respectively comprises two fluid lines that connect the heat exchanger 30 to the drive train 20, the computing unit 10, and the cooler K. Of these two fluid lines, one respectively forms a supply line and the other respectively a return line for a liquid medium. The heat exchanger 30, moreover, comprises an electronic control unit and several valves, which are provided for interconnection of the fluid lines with one another. Details relating to the construction of the heat exchanger 30 are not shown. If, for example, a journey is started after a cold start of the vehicle 100, wherein the actual temperature of the drive train 20 is lower than its lower operating temperature threshold, an exchange of data between the computing unit 10 and the server S can be carried out by the computing unit 10 as per the method described herein. As a result of the computations that occur during this exchange of data, the computing unit 10 generates computing heat, which is used to heat the drive train 20. In this case, the heat exchanger 30 is controlled in such a way that fluid in the computing unit 10 absorbs heat, is fed to the drive train 20 through the corresponding fluid lines and there once again releases the heat. In another case, in which the drive train 20 has already reached its operating temperature, the heat exchanger 30 can, for example, be controlled so that fluid flows from the computing unit 10 to the cooler K, where the fluid is passively cooled. As an alternative to the described embodiment of the heat exchanger 30, the heat exchanger can also be configured differently, for example, as a heat pump with two or a plurality of temperature levels.

German patent application no. 10 2023 125573.8, filed Sep. 21, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for thermal control of a plurality of components in a vehicle, wherein the vehicle comprises as a component at least one computing unit which is configured to execute computations in the vehicle, wherein computing heat is generated in the computing unit during these computations, and the vehicle comprises as a further component at least one drive train which drive train is provided to drive the vehicle and which generates drive heat during operation, wherein the computing unit is configured to execute computations required for the operation of the vehicle and to carry out a repeated exchange of data with a server arranged outside the vehicle in order to compare vehicle data with centrally stored data, the method comprising:
determining an actual temperature of the computing unit and an actual temperature of the at least one drive train; and
carrying out the exchange of data between the computing unit and the server when the actual temperature of the drive train is below a lower operating temperature threshold of the drive train, wherein the computing heat generated during the exchange of data is fed at least in part to the drive train in order to increase the actual temperature of the drive train.

2. The method according to claim 1, wherein the exchange of data between the computing unit and the server is carried out at a beginning of a journey, after a rest period of the vehicle, or after a cold start of the vehicle, and data which were determined in the vehicle before the rest period of the vehicle are transmitted during the exchange of data.

3. The method according to claim 1, wherein when the actual temperature of the drive train is higher than a lower operating temperature threshold of the drive train, an exchange of data between the computing unit and the server is only carried out if the computing heat generated thereby can be dissipated by a passive cooling system of the vehicle.

4. The method according to claim 3, wherein the computing heat generated by the exchange of data is emitted to an environment of the vehicle by a cooler and/or the time for exchange of data between the computing unit and the server is determined by the computing unit on the basis of temperature sensors, cameras or a weather forecast.

5. The method according to claim 1 wherein if the actual temperature of the drive train is below a lower operating temperature threshold of the drive train, in addition to or as an alternative to the exchange of data between the computing unit and the server, a computation independent of the operation of the vehicle is executed by the computing unit and the thereby generated computing heat is at least partially fed to the drive train.

6. The method according to claim 1, wherein the computing unit predicts a behavior of one or a plurality of drivers of the vehicle based on data collected about a respective driver and/or based on data provided by the respective driver, and, if the actual temperature of the drive train is below a lower operating temperature threshold of the drive train, the exchange of data between the computing unit and the server is at least partially executed before the journey of the vehicle is started and the computing heat generated during the exchange of data is at least partially fed to the drive train in order to preheat the drive train.

7. The method according to claim 6, wherein the data collected related to the respective driver comprises known, previously driven routes, known speed profiles, and/or known travel times and/or the data provided by the respective driver comprises entries from a calendar or explicitly entered driving plans and/or the respective driver is asked before the start of the journey whether they want to drive a known route.

8. The method according to claim 6, wherein, in a case in which the actual temperature of the drive train is higher than a lower operating temperature threshold of the drive train, an exchange of data between the computing unit and the server is undertaken, if, in accordance with a predicted behavior of the respective driver of the vehicle, the generated computing heat can be dissipated by a passive cooling system of the vehicle, or if the actual temperature of the drive train is predicted to fall below the lower operating temperature threshold of the drive train and thereby there is a need to transfer the computing heat generated during the exchange of data to heat the drive train.

9. A device for thermal control of a plurality of components in a vehicle, comprising:
at least one computing unit that forms a component of the vehicle and is configured to execute computations in the vehicle;
at least one drive train that forms a component of the vehicle and is provided to drive the vehicle; and
at least one heat exchanger, which is thermally connected at least to the computing unit and the drive train,
wherein the computing unit is configured to execute a method comprising determining an actual temperature of the computing unit and an actual temperature of the drive train, and carrying out an exchange of data between the computing unit and a server when the actual temperature of the drive train is below a lower operating temperature threshold of the drive train, wherein computing heat generated during the exchange of data is fed at least in part to the drive train in order to increase the actual temperature of the drive train, and
wherein the heat exchanger is configured, in a controlled manner through the computing unit, to transfer heat from the computing unit to the drive train or vice versa.

10. A vehicle with a device according to claim 9.
